(19) United States
(12) Patent Application Publication
(10) Pub. No.: US 2005/0012344 A1
(43) Pub. Date: Jan. 20, 2005

(54) Chassis fairing latch with integral handle

(75) Inventors: Michael C. Sorrells, Greensboro, NC (US); David W. Conrad, Kernersville, NC (US)

Correspondence Address: WATTS, HOFFMANN, FISHER & HEINKE CO., L.P.A., STE. 1750, 1100 SUPERIOR AVE., CLEVELAND, OH, 44114, US

(73) Assignee: Volvo Trucks North America, Inc.

(21) Appl. No.: 10/619,407

(22) Filed: Jul. 15, 2003

(51) Int. Cl. E05C 1/12

(52) U.S. Cl. 292/169

(57) ABSTRACT

A latch assembly for moving a latching pin a vertical distance between a latch position and an unlatch position. A rotatable handle defines a plane of rotation when rotated about an axis of rotation and a latching pin is connected to the rotatable handle. The central axis of the latching pin is perpendicular to the plane of rotation and coincident with the axis of rotation. A latching pin guide member engages and guides the latching pin along the central axis in response to rotation of the handle.

### TECHNICAL FIELD

The invention relates generally to the field of over-the-highway tractor trailers and more specifically to an aerodynamic chassis fairing having a latch with an integral handle.

### BACKGROUND OF THE INVENTION

Because fuel economy is a major consideration for over-the-highway tractor trailers that travel long distances, most of these tractors feature various exterior features, such as fairings that smooth the surface of the vehicle. Step assemblies and fuel tanks create air turbulence and thereby reduce fuel efficiency. Chassis or cab skirt fairings are aimed at reducing the air turbulence caused by these components. While these fairings are effective in increasing fuel economy, they obstruct access to vehicle components. Removal of the fairing panels can be cumbersome, often requiring two people and special tools, making maintenance more costly.

### SUMMARY OF THE INVENTION

Translating the rotary motion of a handle into lateral latching motion enables easy removal of a detachable panel. The present invention provides an apparatus for moving a latching pin a vertical distance between a latch position and an unlatch position. A rotatable handle defines a plane of rotation when rotated about an axis of rotation and a latching pin is connected to the rotatable handle. The central axis of the latching pin is perpendicular to the plane of rotation and coincident with the axis of rotation. A latching pin guide member engages and guides the latching pin along the central axis in response to rotation of the handle. In a preferred embodiment, the guide member is a cam housing that is disposed circumferentially about the latching pin and has a circumferential cam slot that defines an arc having a vertical component equal to the vertical distance and a circumferential component equal to a predetermined amount of rotation of the rotatable handle. The cam pin that protrudes through the cam slot is fixed perpendicular to the latching pin and rides in the cam slot to guide the latching pin along the vertical distance in response to rotation of the handle.

In a preferred embodiment, a biasing spring urges the latching pin toward the latch position. A keeper channel may be defined through which a distal end of the latching pin extends. The cam pin may protrude through the handle and the latching pin to fix the handle and latching pin together.

In an exemplary embodiment, the arc defined by the cam slot has a flattened or detent portion at an end corresponding to the latch position of the latching pin. The handle may be adapted to serve as a carrying handle for the detachable panel.

Other features, benefits and advantages of the invention will be apparent from the following detailed description of preferred embodiments thereof taken in conjunction with the following drawing figures.

### BRIEF DESCRIPTION OF THE DRAWINGS

FIG. 1 is a side view of an over-the-highway heavy-duty truck having latching assemblies in accordance with an embodiment of the present invention;

FIG. 1A is a cut away view of the truck of FIG. 1 showing the latching assemblies;

FIG. 2 is a perspective view of a fairing latch constructed in accordance with an embodiment of the present invention;

FIG. 3 is a cross section of the latch of FIG. 2; and

FIG. 4 is a rotated cross section of the latch of FIG. 2.

### DETAILED DESCRIPTION OF THE PREFERRED EMBODIMENT

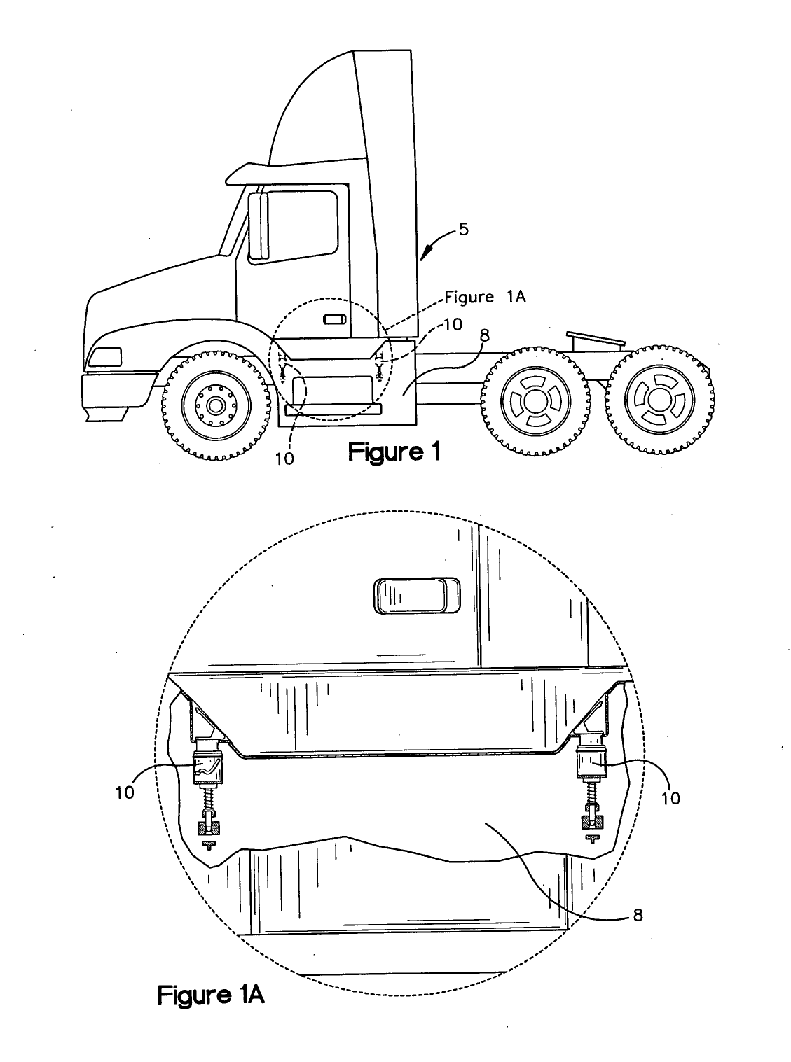

FIG. 1 is an overview of an over-the-highway heavy-duty truck that has a fairing panel 8 mounted to the cab by a pair of latches 10. As can be seen in more detail in FIG. 1A, the latches 10 are accessible from outside the vehicle and are actuated to disengage and pivot the fairing panel 8 away from the truck to remove the panel. As can be readily seen in FIGS. 1 and 1A, the amount of space in which to package the latch is limited. Further, ergonomic factors dictate that the latch be easy to actuate and also that the latch co act with the panel to facilitate panel removal.

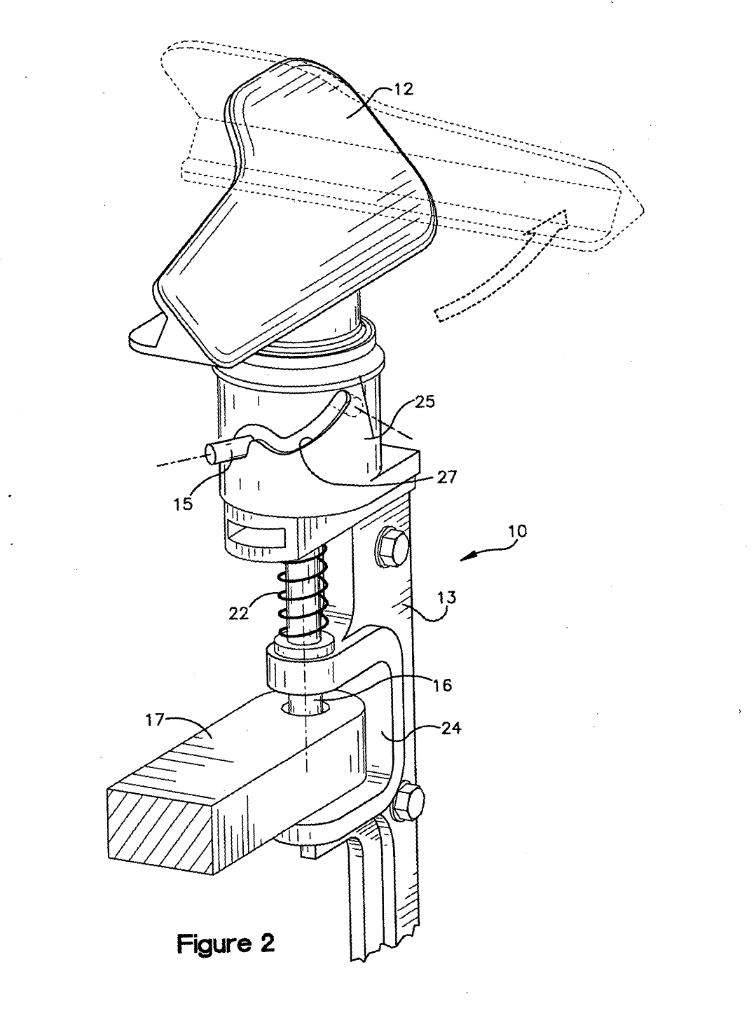

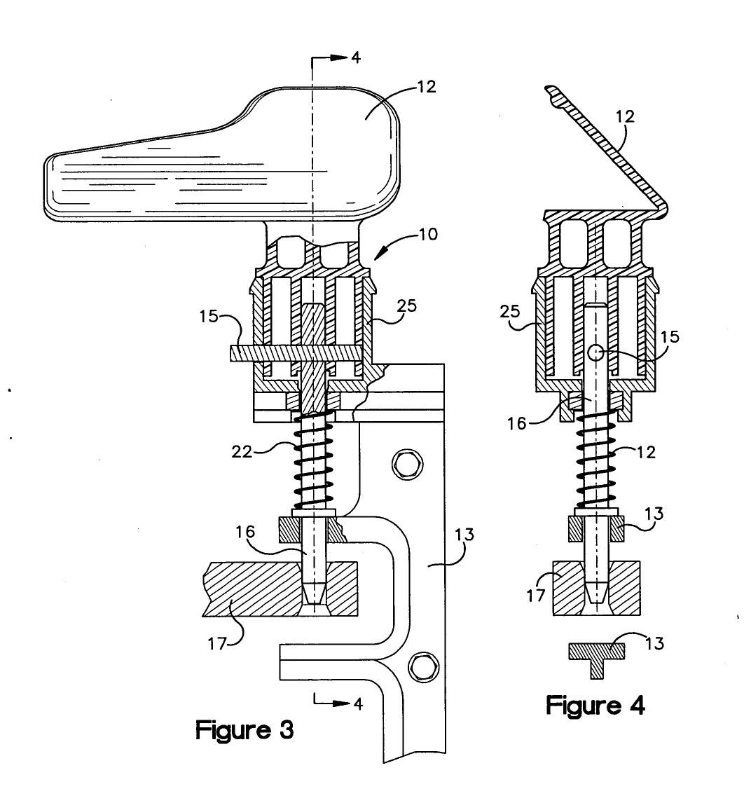

FIG. 2 shows a more detailed perspective view of the latch 10. A fairing mounting flange 17 extends from a frame on the tractor and provides a mounting hole for a latch pin 16 on the fairing latch 10 to retain the fairing in position relative to the frame. The fairing latch 10 includes a latch frame member 13 with a c-shaped channel 24 that is sized to accept the fairing mounting flange 17 with a relatively close fit. A handle 12 is fixed to the latch pin 16 by a threaded set-screw retaining pin 15 (see FIG. 3 for more detail). The handle 12 is maintained within housing a 25 that is integral to the latch frame member 13. To minimize the amount of space taken up by the handle 12, the handle is directly connected to the latch pin such that the extension of the handle that is gripped by the operator is generally perpendicular to the latch pin 16 so that rotation of the handle translates directly into rotation of the latch pin. The perpendicular arrangement of the handle with respect to the latch pin also allows for the fairing to be carried by the handle.

The housing 25 features a inclined slot 27 within which the retaining pin 15 rides. The latch pin 16 extends from the handle 12 (see FIGS. 3 and 4), through the latch frame member 13 and a biasing spring 22 that concentrically surrounds the latch pin 16 and urges the handle 12 and latch pin 16 in a downward or latched direction. A distal end of the latch pin 16 extends into the c-shaped channel 24 when the latch 10 is in the closed position and above the c-shaped channel when the latch is in the open position.

To open the latch 10, the handle 12 is rotated to the position shown in phantom in FIG. 2. As the handle is rotated against the biasing force of the spring 22 the retaining pin 15 rides up the inclined slot 27 to move the handle 12 and the latch pin 16 upward and out of the mounting flange 17. When the handle is released, the biasing spring 22 moves that latch pin back to the latched position and thereby rotates the handle 12 back to its latched position. The handle 12 can be used to carry the fairing panel away from the tractor. To close the latch when the panel is installed on the tractor, the handle is released or rotated back to the position shown in FIG. 2. During rotation, the retaining pin 15 rides down the inclined slot 27, assisted by the biasing force of the spring 22, to engage the mounting flange 17. The retaining pin 15 engages a flattened or detent portion of the inclined slot 27 that maintains the split pin in the closed position.

While the invention is described in conjunction with an over-the-highway tractor trailer, the inventive fairing latch and handle can be used on any removable panel where it is beneficial to translate manual rotation into a lateral latching motion.

1. An apparatus for moving a latching pin a lateral distance between a latch position and an unlatch position comprising;
a rotatable handle that defines a plane of rotation when rotated about an axis of rotation;
a latching pin connected to the rotatable handle wherein a central axis of the latching pin is substantially perpendicular to the plane of rotation and substantially coincident with the axis of rotation of the handle; and
a latching pin guide that engages and guides the latching pin along the central axis in response to rotation of the handle.

2. The apparatus of claim 1 wherein the latching pin comprises a cam pin that engages the latching pin guide.

3. The apparatus of claim 2 wherein the cam pin is fixed to the latching pin perpendicular to the central axis of the latching pin and wherein the latching pin guide comprises a cam disposed circumferentially about the latching pin and wherein the cam commprises a circumferential cam slot that defines an arc having a lateral component equal to the lateral distance and a circumferential component equal to a predetermined amount of rotation of the rotatable handle, and wherein the cam pin protrudes through the cam slot and rides in the cam slot to guide the latching pin along the lateral distance in response to rotation of the handle.

4. The apparatus of claim 1 comprising a biasing spring that urges the latching pin toward the latch position.

5. The apparatus of claim 1 comprising a keeper channel into which a distal end of the latching pin extends.

6. The apparatus of claim 3 wherein the cam pin protrudes through the handle and the latching pin to fix the handle and latching pin together.

7. The apparatus of claim 3 wherein the arc defined by the cam slot has a detent portion at an end corresponding to the latch position of the latching pin.

8. The apparatus of claim 1 wherein the handle and latching pin are connected to a detachable panel.

9. The apparatus of claim 8 wherein the handle is adapted to be a carrying means for the detachable panel when it is detached.

10. The apparatus of claim 1 wherein a grip extension of the handle extends along an axis generally perpendicular to the central axis of the latching pin.

11. The apparatus of claim 1 wherein the handle is rigidly connected to the latching pin.

12. A fairing system comprising at least one fairing for being installed on a side of a truck, the fairing comprising a hinge at a lower portion about which the fairing is pivoted between a closed position and an open position, the fairing system also comprising an apparatus for removably latching the fairing to the truck, the apparatus comprising:
a rotatable handle that defines a plane of rotation when rotated about an axis of rotation;
a latching pin connected to the rotatable handle wherein a central axis of the latching pin is substantially perpendicular to the plane of rotation and substantially coincident with the axis of rotation of the handle; and
a latching pin guide that engages and guides the latching pin along the central axis in response to rotation of the handle, wherein the latching pin engages latching features on the truck to maintain the fairing in the closed position.

13. The apparatus of claim 12 wherein the latching pin comprises a cam pin that engages the latching pin guide.

14. The apparatus of claim 13 wherein the cam pin is fixed to the latching pin perpendicular to the central axis of the latching pin and wherein the latching pin guide comprises a cam disposed circumferentially about the latching pin and wherein the cam commprises a circumferential cam slot that defines an arc having a lateral component equal to the lateral distance and a circumferential component equal to a predetermined amount of rotation of the rotatable handle, and wherein the cam pin protrudes through the cam slot and rides in the cam slot to guide the latching pin along the lateral distance in response to rotation of the handle.

15. An apparatus for moving a latching pin a lateral distance between a latch position and an unlatch position comprising;
rotatable hand grip means that define a plane of rotation when rotated about an axis of rotation;
latching means connected to the hand grip means wherein a central axis of the latching means is substantially perpendicular to the plane of rotation and substantially coincident with the axis of rotation of the hand grip means; and
guide means that engages and guides the latching means along the central axis in response to rotation of the handle.

16. The apparatus of claim 15 wherein the latching means comprises a cam pin that engages the latching pin guide.

17. The apparatus of claim 16 wherein the cam pin is fixed to the latching means perpendicular to the central axis of the latching means and wherein the guide means comprises a cam disposed circumferentially about the latching means and wherein the cam comprises a circumferential cam slot that defines an arc having a lateral component equal to the lateral distance and a circumferential component equal to a predetermined amount of rotation of the rotatable handle, and wherein the cam pin protrudes through the cam slot and rides in the cam slot to guide the latching means along the lateral distance in response to rotation of the handle.

18. The apparatus of claim 15 comprising a biasing means that urges the latching means toward the latch position.

19. The apparatus of claim 17 wherein the arc defined by the cam slot has a detent portion at an end corresponding to the latch position of the latching means.

20. The apparatus of claim 15 wherein a grip extension of the hand grip means extends along an axis generally perpendicular to the central axis of the latching pin.

21. The apparatus of claim 15 wherein the hand grip means is rigidly connected to the latching means.
